(19) United States
(12) Patent Application Publication
(10) Pub. No.: US 2018/0089702 A1
(43) Pub. Date: Mar. 29, 2018

(54) SYSTEMS AND METHODS FOR COLLECTING POLITICAL AND CONSUMER INFORMATION

(71) Applicants: William Arthur Golden, Savannah, GA (US); Max Lesares Golden, Savannah, GA (US)

(72) Inventors: William Arthur Golden, Savannah, GA (US); Max Lesares Golden, Savannah, GA (US)

(21) Appl. No.: 15/717,935

(22) Filed: Sep. 27, 2017

Related U.S. Application Data
(60) Provisional application No. 62/400,396, filed on Sep. 27, 2016.

(51) Int. Cl. G06Q 30/02

(52) U.S. Cl. CPC G06Q 30/0201; G06F 2221/2133

(57) ABSTRACT

Implementations of systems and methods for collecting political and consumer information are provided. Implementations of a system for collecting political and consumer information according to the present receive a request for information at a first computing device from a second computing device. In response to the request, the first computing device transmits information to render a user interface on the second computing device wherein the information transmitted comprises a test configured to tell a computer or human apart wherein the test comprises political content and poses a question regarding the political content. When a response to the test is received at the first computing device, it is determined whether to transmit the requested information to the second computing device based on whether the user is determined to be a computer. In some implementations, the response and demographic information related to the response are stored.

### CROSS REFERENCE TO RELATED APPLICATION

This application claims the benefit of U.S. Patent Application Ser. No. 62/400,396, which was filed on Sep. 27, 2016, and is incorporated herein by reference in its entirety.

### TECHNICAL FIELD

This disclosure relates to systems and methods for collecting political and consumer information.

### BACKGROUND

Currently, political polling data is captured by, for example, calling landlines and surveying the resident at the landline number. There exist some online polls, however, these polls can be manipulated using programs.

### BRIEF DESCRIPTION OF THE DRAWINGS

FIG. 1 illustrates an implementation of an example polling environment for capturing survey or polling data such as political information or consumer information.

FIG. 2 illustrates an implementation of an example computer system, which may be used with implementations of the present disclosure.

FIG. 3 illustrates an example CAPTCHA user interface.

FIGS. 4-6 illustrate implementations of example user interfaces according to the present disclosure.

### DETAILED DESCRIPTION

The present disclosure relates to systems and methods for capturing survey or polling data such as political information or consumer information. Implementations of a system for collecting political and consumer information according to the present receive a request for information at a first computing device from a second computing device. In response to the request, the first computing device transmits information to render a user interface on the second computing device. In some implementations, the information transmitted comprises a test configured to tell a computer or human apart and the test comprises political content and poses a question regarding the political content. In some implementations, when a response to the test is received at the first computing device, it is determined whether to transmit the requested information to the second computing device based on whether the user is determined to be a computer. In some implementations, the response and demographic information related to the response are stored.

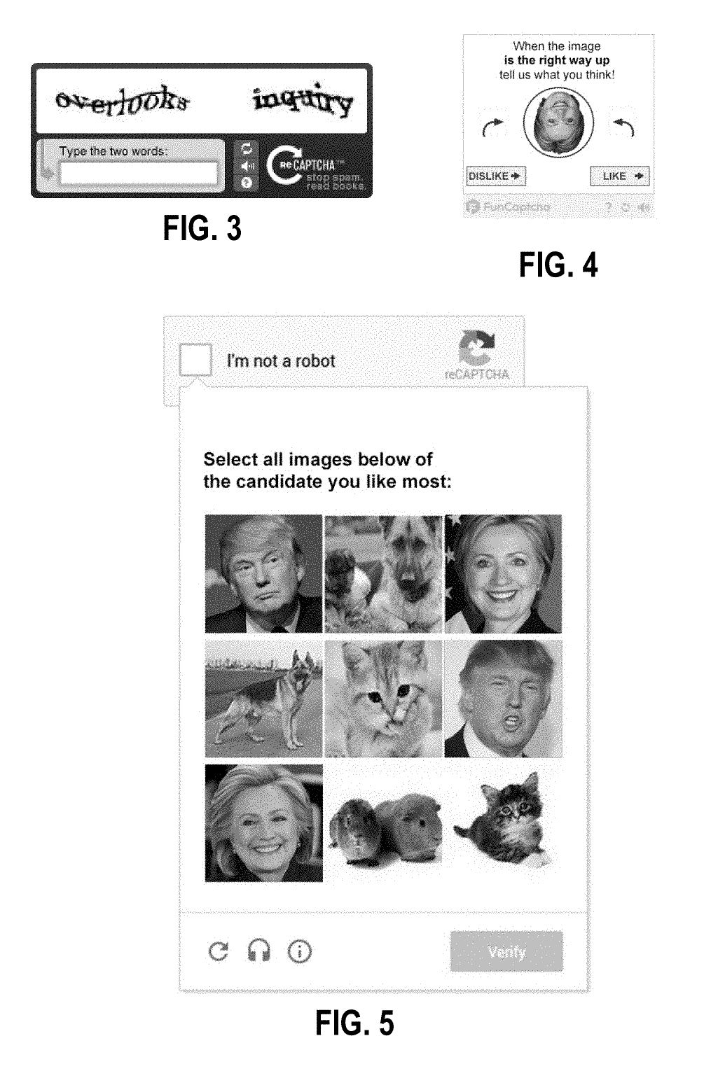

Generally, CAPTCHA (Completely Automated Public Turing Test To Tell Computers and Humans Apart) technology requires a user to prove that he/she is not a computer by inputting information requested before proceeding to a page. FIG. 3 illustrates an example CAPTCHA user interface. Using CAPTCHA technology, a user is not able to pass a page until the user provides the correct input.

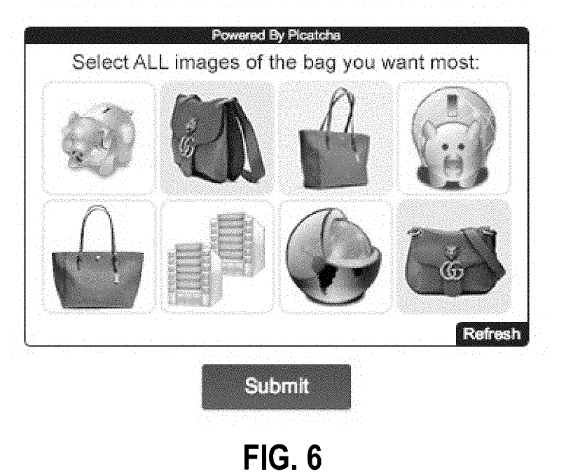

In some implementations, the present disclosure is similar to CAPTCHA technology in that a user cannot proceed to a page on a web or mobile platform until he/she establishes that he/she is not a computer but, in some implementations, the user also must answer a political-related question posed. FIGS. 4-5 illustrate implementations of example user interfaces according to the present disclosure for collecting political-related information. In some implementations, political-related questions may include, but is not limited to, questions of or relating to government including parties and persons involved with government or that desire to be involved with government, a government, or the conduct of government. Political-related questions may include, but is not limited to, questions or of, relating to, involving, or involved in politics and especially party politics.

In some implementation, when accessing a page on a web or mobile platform, a user is directed to an intermediary page where the user must establish that he/she is not a computer and must answer a political-related question posed before proceeding to the page. In some implementations, the political-related questions include tests that humans can pass but computer programs cannot pass or may have difficulty passing. In some implementations, the answers are collected and stored to gather polling data. In some implementations, the answers are stored only if the user establishes that the user is not a computer.

For example, if the demographics (e.g., age, gender, race, income level, etc.) is known of the users of a particular application that requires verification before proceeding, then the demographics of the answers collected from the verification can be estimated based on the known demographics of the users of the application without requesting this information from the user. In some implementations, the demographics of the answers collected may be equal to the demographics of the users of the particular application. In some implementations, the demographics of the answers collected may be a function of to the demographics of the users of the particular application.

In some implementations, the demographics of a user of the present disclosure may be known. For example, in some implementation, a user of the present disclosure may be asked demographic-related questions.

Similarly, in some implementations of the present disclosure, consumer information is collected. FIG. 6 illustrates an implementation of example user interfaces according to the present disclosure for collecting consumer information. That is, a user cannot proceed to a webpage until he/she proves that he/she is not a computer and answers a consumer-related question posed.

In some implementations, the political or consumer-related questions are neutral. In some implementations, the political or consumer-related questions are not intended to influence the user. In some implementations, the political or consumer-related questions are intended to merely collect information. For example, in some implementations, the consumer-related questions are not advertisements.

In some implementations, the political or consumer-related questions are not neutral. In some implementations, the political or consumer-related questions are intended to influence the user. In some implementations, the political or consumer-related questions are not intended to merely collect information. For example, in some implementations, the consumer-related questions are advertisements.

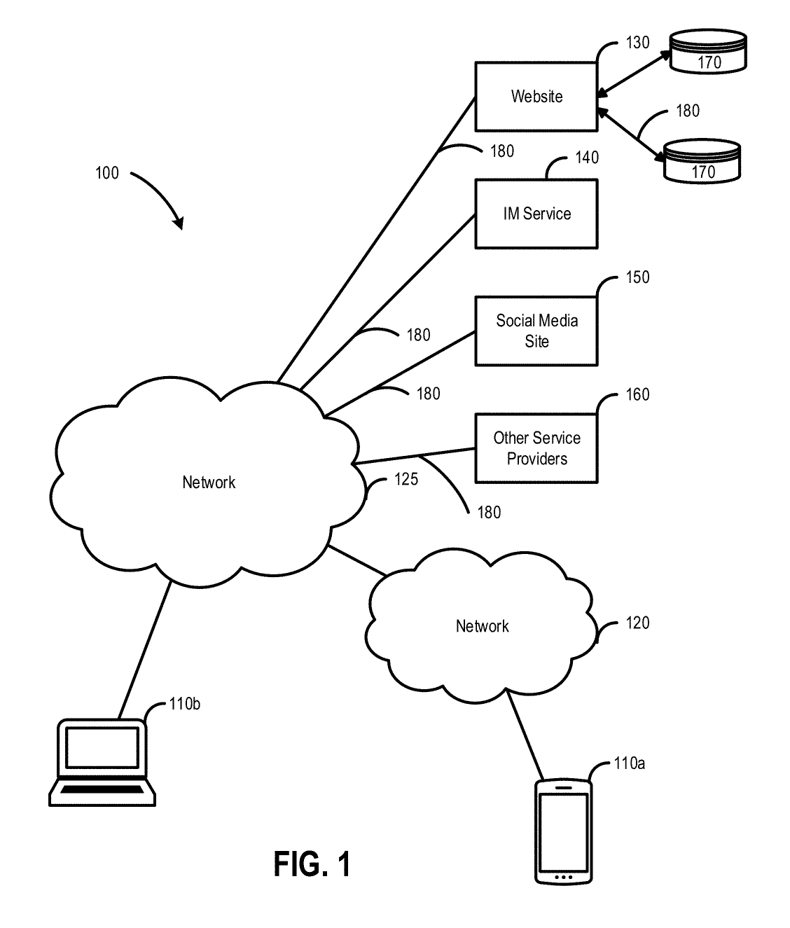

FIG. 1 illustrates an implementation of an example polling environment 100 for capturing survey or polling data such as political information or consumer information.

As shown in FIG. 1, the polling environment 100 can include voter devices 110a and 110b (collectively voter device 110), a wireless cellular network 120, a network 125, a website 130, an instant message (IM) service 140, a social media site 150, and/or other service providers 160.

Voter devices 110a and 110b are depicted as a mobile phone 110a and desktop computer 110b, respectively, but voter devices 110 may comprise any type of computing device, such as a desktop computer system, a laptop, cellular phone, a smart device, a mobile telephone, a tablet-style computer, or any other device capable of wireless or wired communication.

Similarly, website 130, instant message (IM) service 140, social media site 150, and other services providers 160 (collectively “service provider devices 160”) may comprise any type of computing device, such as a desktop computer system, a laptop, cellular phone, a smart device, a mobile telephone, a tablet-style computer, one or more servers, or any other device capable of wireless or wired communication.

The polling environment 100 also can include one or more data storage 170 linked to a service provider 130, 140, 150, 160. In some implementations, applications used to render the user interfaces to perform the functions described above (e.g., inputting data to establish that user is not a computer, answering a political-related question, etc.) may be written in software programs hosted by a service provider 130, 140, 150, 160.

In some implementations, voter devices 110 and/or service provider devices 160 may include one or more processors, one or more memories, one or more displays, one or more interfaces, one or more components capable of inputting data, one or more components capable of outputting data, one or more components capable of communicating with any other component of the polling environment 100, or any other component suitable for a particular purpose.

In some implementations, each voter device 110 may be an electronic device including hardware, software, or embedded logic components or a combination of two or more such components and capable of carrying out the appropriate functions implemented or supported by voter device 110.

In some implementations, the voter device 110a can connect to the network 125 through a wireless cellular network 120, such as GPRS-based and CDMA-based wireless networks, as well as 802.16 WiMax and long-range wireless data networks.

In some implementations, voter devices 110a and 110b interact with external websites (e.g., website 130) and other service providers 140, 150, and 160 via an application, such as a web browser or a native application, residing on the voter devices 110a and 110b to establish that the user is not a computer and for the user to answer a political or consumer-related question posed. For example, voter devices 110a and 110b may interact with a social media site, such as Twitter, via a browser or through a dedicated Twitter application. Other service providers 160 may include, but is not limited to, e-mail servers, other social-networking websites, shopping sites, review sites, any third-party website on which a user maintains an account to interact with content or other users, or any other third-party website. This disclosure contemplates any type of service provider 160 connected to network 125.

Components of the polling environment 100 may communicate with any other component of the polling environment 100 over network 125 and/or network 120. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the polling environment 100 may be configured to communicate over links 180. Links 180 may connect components of the polling environment 100 to networks 120, 125 or to each other. In some implementations, one or more links 180 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 180 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 180. Links 180 may not be the same throughout the polling environment 100.

In some implementations, each service provider 160 may be a unitary server or may be a distributed server spanning multiple computers or multiple datacenters. Servers 160 may be of various types, such as, for example and without limitation, web server, file server, application server, exchange server, database server, or proxy server. In some implementations, each server 160 may include hardware, software, or embedded logic components or a combination of two or more such components for carrying out the appropriate functionalities implemented or supported by server 160. For example, a web server is generally capable of hosting websites containing web pages or particular elements of web pages. More specifically, a web server may host HTML files or other file types, or may dynamically create or constitute files upon a request, and communicate them to voter devices 110 in response to HTTP or other requests from voter devices 110. A database server is generally capable of providing an interface for managing data stored in one or more data stores.

In some implementations, one or more data storages 170 may be communicatively linked to one or more servers 160 via one or more links 180. In some implementations, data storages 170 may be used to store various types of information (e.g., results for political or consumer related question, demographic information, etc.). In some implementations, the information stored in data storages 170 may be organized according to specific data structures. In particular embodiment, each data storage 170 may be a relational database. Particular embodiments may provide interfaces that enable servers 170 or voter devices 110 to manage, e.g., retrieve, modify, add, or delete, the information stored in data storage 170.

In some implementations, a voter device 110 may have a web browser, such as MICROSOFT INTERNET EXPLORER, GOOGLE CHROME, MOZILLA FIREFOX, or any other future developed web browser and may have one or more add-ons, plug-ins, or other extensions. A user at voter device 110 may enter a Uniform Resource Locator (URL) or other address directing the web browser to a service provider/server 160, and the web browser may generate a Hyper Text Transfer Protocol (HTTP) request and communicate the HTTP request to server 160. Server 160 may accept the HTTP request and communicate to voter device 110 one or more Hyper Text Markup Language (HTML) files responsive to the HTTP request. Voter device 110 may render a web page based on the HTML files from server 160 for presentation to the user. In some implementations, the web page rendered may include a test to establish that the user is not a computer and pose one or more political or consumer related questions (see, e.g., FIGS. 4, 5, and 6).

The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In some implementations, a user at a voter device 110 having a web browser can connect to a server 160 and establish that he/she is not a computer and answers a political or consumer related question posed. In some implementations, input received from the user may be stored in a data storage 170 communicatively linked to the servers 160.

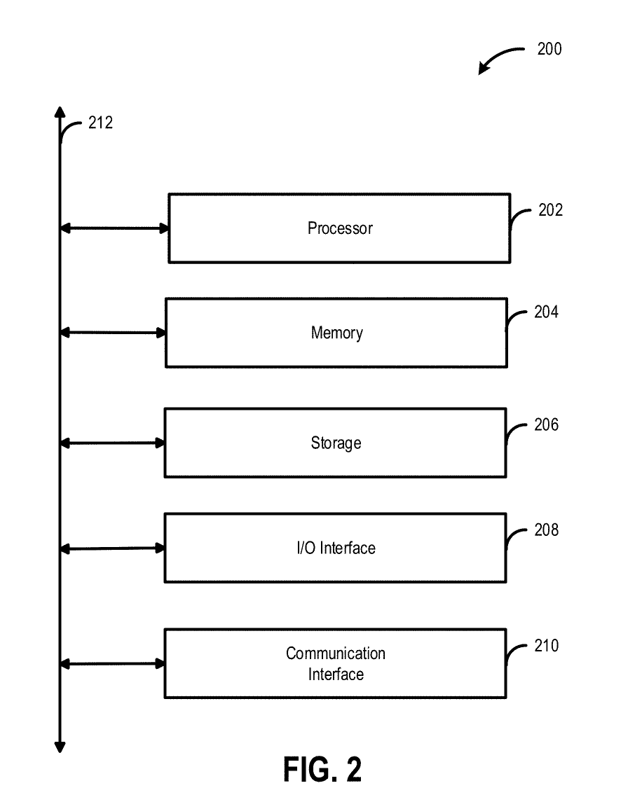

FIG. 2 illustrates an example computer system 200. In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200. Herein, reference to a computer system may encompass a computing device, and vice versa, where appropriate. Moreover, reference to a computer system may encompass one or more computer systems, where appropriate.

Computer system 200 may be any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these. Where appropriate, computer system 200 may include one or more computer systems 200; be unitary or distributed; span multiple locations; span multiple machines; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In some implementations, processor 202 may include one or more internal caches for data, instructions, or addresses. The present disclosure contemplates processor 202 including any suitable number of any suitable internal caches, where appropriate. As an example and not by way of limitation, processor 202 may include one or more instruction caches, one or more data caches, and one or more translation look-aside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In some implementations, one or more memory management units (MMUs) reside between processor 202 and memory 204 and facilitate accesses to memory 204 requested by processor 202. In some implementations, memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 204 may include one or more memories 202, where appropriate. Although this disclosure describes and illustrates particular memory, this disclosure contemplates any suitable memory.

In some implementations, storage 206 includes mass storage for data or instructions. As an example and not by way of limitation, storage 206 may include an HDD, a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In some implementations, storage 206 is non-volatile, solid-state memory. In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate. In some implementations, a computer-readable storage medium implements RAM or ROM. In some implementations, a computer-readable storage medium implements volatile or persistent memory. In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In some implementations, software includes one or more application programming interfaces (APIs). This disclosure contemplates any suitable software written or otherwise expressed in any suitable programming language or combination of programming languages. In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code). In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, it will be apparent to one of ordinary skill in the art that the invention may be used with any electronic network service, even if it is not provided through a website. Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

1. A computer-implemented method, the method comprising:
receiving a request for information at a first computing device wherein the request for information is transmitted over a network from a second computing device; and
transmitting, in response to the request, information to render a user interface on the second computing device wherein the information transmitted comprises a test configured to tell a computer or human apart wherein the test comprises political content and poses a question regarding the political content.

2. The computer-implemented method of claim 1, the method further comprising
displaying a user interface on the second computing device comprising the test for inputting a response to the test;
receiving from an input device at the second computing device the response to the test; and
sending the response over a network to the first computing device.

3. The computer-implemented method of claim 1 further comprising receiving a response to the test at the first computing device wherein the response to the test is transmitted over a network from the second computing device and determining whether to transmit the requested information to the second computing device based on the response to the test and storing the response.

4. The computer-implemented method of claim 1 further comprising estimating demographic information associated with the response based on pre-stored demographic information stored before receiving the request for information.

5. The computer-implemented method of claim 1 wherein the request for information comprises a request to access a page on a website.

6. A non-transitory computer readable medium containing instructions that, when executed by a processor on a first computing device, cause the computing device to:
display a user interface on the first computing device comprising a test for inputting a response to the test wherein the test is configured to tell a computer or human apart wherein the test comprises political content and poses a question regarding the political content;
receive from an input device at the first computing device a response to the test; and
send the response over a network to a second computing device.
